(19) United States
(12) Patent Application Publication
(10) Pub. No.: US 2020/0018184 A1
(43) Pub. Date: Jan. 16, 2020

(54) SYSTEM FOR DEOILING AN AIR-OIL MIXTURE FOR PRESSURISING SEALS OF A TURBINE ENGINE

(71) Applicant: SAFRAN HELICOPTER ENGINES, Bordes (FR)

(72) Inventors: Benjamin FULLERINGER, Moissy-Cramayel (FR); Jean-Pierre PAJARD, Moissy-Cramayel (FR)

(73) Assignee: Safran Helicopter Engines, Bordes (FR)

(21) Appl. No.: 16/335,459

(22) PCT Filed: Sep. 22, 2017
(86) PCT No.: PCT/FR2017/052542

§ 371 Date: Mar. 21, 2019

(30) Foreign Application Priority Data
Sep. 26, 2016 (FR) 1659017

(51) Int. Cl. F01D 25/18; F16N 39/00

(52) U.S. Cl. CPC F01D 25/18; F16N 7/32; F16N 39/002

(57) ABSTRACT

The disclosure relates to a system for deoiling an air-oil pressurizing mixture for pressurized enclosures of a turbine engine. The system includes at least one centrifugal degasser, at least one mechanical casing of the turbine engine comprising a plurality of mechanical parts, at least one of which is mechanically connected to a drive shaft of the degasser so as to be able to rotate same. The casing is configured to contain an oil mist for lubricating the mechanical parts. The deoiling system also comprises means for isolating the air-oil mixture from the oil mist of the mechanical casing so that the oil mist of the mechanical casing cannot enrich with oil the mixture to be separated by the degasser.

### 1. TECHNICAL FIELD OF THE INVENTION

The invention relates to a deoiling system of an air-oil mixture for pressurising seals or pressurised enclosures of a turbine engine, such as carbon rings, brush seals, labyrinth seals, etc.

### 2. TECHNOLOGICAL BACKGROUND

Turbine engines are complex systems that implement numerous rotating units (turbines, compressor, etc.) that must be equipped with sealing devices. These sealing devices are, for example, constituted by pressurised air labyrinths provided in the vicinity of rotating units, or of brush seals or of carbon rings. For this purpose, air is drawn directly in the air stream of the turbine engine. This air then travels in the turbine engine through different seals provided for this purpose, then is evacuated out of the turbine engine to limit the pressure rise in the other zones of the turbine engine, in particular the reduction gear, the accessory case, etc. Yet, the air, having travelled through various zones of the turbine engine, is charged with oil used for cooling and lubricating of the bearings and pinions of the rotating units. To prevent the oil-charged air from being ejected, to alleviate the environmental impact of turbine engines, to reduce the oil consumption and to limit the filling operations of oil tanks, it is important to provide systems for the deoiling of the pressurising air-oil mixture in order to, on the one hand, be able to retrieve the oil and, on the other hand, to evacuate deoiled air out of the turbine engine.

It is known that such a system for deoiling an air-oil mixture for pressurising the seals or the pressurised enclosures of a turbine engine comprises:

at least one centrifugal degasser comprising an enclosure for the separation of the mixture arranged around a drive shaft, an inlet of the mixture into said enclosure, an outlet of deoiled air and an outlet of oil extracted from said mixture,

at least one mechanical casing of the turbine engine comprising a plurality of mechanical parts, of which at least one is mechanically connected to said drive shaft of said degasser so as to drive it rotationally, said casing being configured to contain an oil mist for lubricating said mechanical parts.

It is also known that the degasser is arranged directly inside the mechanical casing to ensure that it is driven. This mechanical casing comprises a plurality of mechanical parts, of which at least one—a pinion, for example—is mechanically connected, directly or indirectly, to the drive shaft of the degasser to enable the degasser to be rotationally driven. This mechanical casing is typically an accessory case or a reduction gear of the turbine engine.

The unit comprising the mechanical casing and the degasser forms the system for deoiling the pressurised air-oil mixture of the seals or pressurised enclosures.

In a known deoiling system, the air-oil mixture arrives in the mechanical casing to be treated by the degasser, which is arranged directly inside the mechanical casing. Thus, the pressurisation air-oil mixture is mixed with the oil mist present in the mechanical casing, and it is the mixture formed by the pressurisation air-oil mixture and by the oil mist of the mechanical casing that the degasser processes in the separation enclosure.

The inventors have sought to improve the yields of known deoiling systems.

In particular, the inventors have sought to provide a deoiling system that makes it possible to limit, to a minimum, the quantity of oil evacuated towards the outside. In particular, the reduction of the oil consumption of turbine engines remains a major opportunity for progress. This must make it possible to optimise the quantity of oil taken on board and therefore to reduce the mass of the turbine engine. It must also make it possible to increase the duration of the missions. It must also make it possible to reduce the maintenance operations on turbine engines. Finally, it must make it possible to improve the environmental impact of turbine engines.

### 3. AIMS OF THE INVENTION

The invention aims to provide a deoiling system that overcomes at least some of the disadvantages of known systems.

The invention in particular aims at providing, in at least one embodiment, a deoiling system that optimises the yield of degassers.

### 4. DESCRIPTION OF THE INVENTION

For this purpose, the invention relates to a system for deoiling an air-oil mixture for pressurising pressurised enclosures of a turbine engine, said system comprising:

at least one centrifugal degasser comprising an enclosure for the separation of said mixture arranged around a drive shaft, an inlet of the mixture into said enclosure, an outlet of deoiled air and an outlet of oil extracted from said mixture,

at least one mechanical casing of the turbine engine comprising a plurality of mechanical parts, of which at least one is mechanically connected to said drive shaft of said degasser so as to drive it rotationally, said casing being configured to contain an oil mist for lubricating said mechanical parts.

A deoiling system according to the invention is characterised in that it comprises the means to isolate said air-oil mixture with respect to the oil mist of said mechanical casing, such that said oil mist of said mechanical casing cannot enrich with oil, said mixture to be separated by said degasser, and in that it comprises a double degasser configured to be able to process, in a first enclosure, the air of the pressurised enclosures and, in a second enclosure, the air of the mechanical casing.

In other words, the invention implements a physical separation between the air-oil mixture having circulated in the pressurised enclosures of the turbine engine and the mechanical casing participating in rotationally driving the degasser. In particular, the air-oil mixture to be separated by the degasser of the deoiling system is isolated from the oil mist present in the mechanical casing. This isolation prevents the enrichment of the air-oil mixture coming from the pressurised enclosures of the turbine engine with oil coming from the oil mist of the mechanical casing.

A system according to the invention further makes it possible to decrease the temperature of the mechanical casing by limiting the heat exchanges between the air-oil mixture coming from the pressurised enclosures of the turbine engine, which is a hot mixture, and the oil mist of the mechanical casing. A deoiling system according to the invention therefore makes it possible to reduce the cooling needs of the mechanical casing.

The pressurised enclosures of a turbine engine can be formed, according to the selected architectures, by carbon rings, brush seals, labyrinth seals or any equivalent device. Advantageously, and according to the invention, said isolation means of said mixture comprise a duct connecting directly an outlet of said pressurised enclosures to said inlet of said mixture in said enclosure of said degasser so that said mixture of the pressurised enclosures directly supplies said degasser without interacting with said oil mist of the mechanical casing.

According to this version, the deoiling system comprises a duct connecting the outlet of the pressurised enclosures of the turbine engine to the mixture inlet of the degasser. Thus, this duct isolates the circulation of the mixture between the pressurised enclosures from the degasser of the oil mist present in the mechanical casing. This duct makes it possible to prevent the air-oil mixture coming from the pressurised enclosures from being enriched with the lubricating oil coming from the mechanical casing.

Advantageously and according to this version, the degasser is housed in said mechanical casing and said duct passes through said mechanical casing.

This advantageous version makes it possible to retain an architecture that is similar to the architecture of known systems, i.e. to maintain the degasser in the mechanical casing, while isolating the mixture from the mist by the implementation of a duct between the inlet of the degasser and the pressurised enclosures. For this purpose, the duct passes through the mechanical casing.

Advantageously, and according to this version, said drive shaft of said degasser is hollow and forms at least one portion of said duct connecting said pressurised enclosures of the turbine engine to the inlet of the degasser.

For example, according to an advantageous version of the invention, said drive shaft of said degasser is hollow and makes it possible for the mixture to be suctioned into the enclosure between the mechanical casing and an air inlet casing of a compressor of the turbine engine.

This version makes useful use of the drive shaft of the degasser so that it plays, in addition to the role thereof of driving the degasser, a role of routing the mixture to be separated and of isolating the mixture from the oil mist present in the mechanical casing.

Advantageously, and according to another version of the invention, said degasser is arranged outside of said mechanical casing and said drive shaft of said degasser passes through said mechanical casing, said mechanical casing forming said isolation means of said mixture with respect to the oil mist.

According to this version, the degasser is arranged outside the mechanical casing, the casing of the mechanical casing thereby forming the isolation means of the mixture with respect to the oil mist.

For example, according to an advantageous version of the invention, the degasser is arranged between the mechanical casing and an air inlet casing of a compressor of the turbine engine.

Advantageously, and according to the invention, said mechanical casing is a reduction gear casing or an accessory case of the turbine engine.

Advantageously, and according to the invention, the oil outlet of said degasser opens into said mechanical casing.

According to this version, the oil extracted by the degasser can be used to lubricate the mechanical parts of the mechanical casing.

The invention also relates to a turbine engine comprising a deoiling system according to the invention.

With an improved oil recovery system, a turbine engine according to the invention equipped with a deoiling system according to the invention uses less oil than a turbine engine according to the prior art. A turbine engine according to the invention is lighter than a turbine engine according to the prior art. The duration of a mission of a helicopter equipped with turbine engines according to the invention is therefore longer. Furthermore, maintenance operations are less frequent. Finally, the environmental impact of a turbine engine according to the invention is improved with respect to turbine engines according to the prior art.

The invention also relates to a degasser and a turbine engine characterised in combination by all or some of the characteristics mentioned above or below.

### 5. LIST OF FIGURES

Other aims, characteristics and advantages of this invention will appear upon reading the following description, provided by way of an example and not limited thereto, and with reference to the appended drawings, wherein:

FIG. 1 is a schematic, functional view of a system for deoiling an air-oil mixture for pressurising seals of a turbine engine according to the prior art,

FIG. 2 is a schematic, functional view of a system for deoiling an air-oil mixture for pressurising seals of a turbine engine according to the invention,

FIG. 3 is a schematic view of a degasser of a deoiling system according to one embodiment of the invention.

### 6. DETAILED DESCRIPTION OF AN EMBODIMENT OF THE INVENTION

In the figures, the scales and proportions are not strictly respected for purposes of clarity and illustration.

The same references are used in different figures for different elements of a deoiling system having an identical function or similar nature.

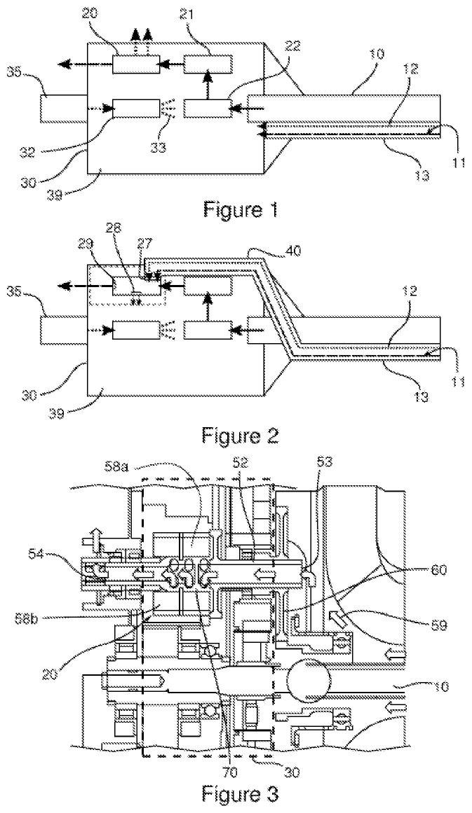

FIG. 1 shows a drive shaft 10 of a turbine engine equipped with a deoiling system according to the prior art. This drive shaft 10 is, for example, the row of shafts of a gas generator and of a free turbine of the turbine engine of a helicopter. Pressurised air, represented by solid-line arrows 11, is injected in the seals to ensure the sealing of the pressurised enclosures 13 of the turbine engine. This air 11 is then charged in oil as it circulates inside the pressurised enclosures 13. In FIG. 1, an air and oil mixture is shown circulating along the shaft 10 of the turbine engine. The dashed lines 11 represent the air and the dotted lines 12 represent the oil of the mixture.

According to the prior art, the deoiling system of the air-oil mixture of the seals 13 comprise a centrifugal degasser 20 housed in an accessory case 30. Such an accessory case comprises a plurality of pinions 21, 22 arranged relative to one another and mechanically connected so as to be able to recover the mechanical power on the drive shaft 10 of the turbine engine and to deliver this mechanical power to various auxiliary features necessary to the functioning of the turbine engine, and in particular to the centrifugal degasser 20, to ensure that it is rotationally driven.

The accessory case 30 further comprises a nozzle 32 intended to provide lubricating oil 33 for the various mechanical parts housed in the accessory case 30, such as, in particular, the pinions 21, 22. This nozzle 32 is supplied with oil by an oil tank 35 arranged outside the accessory case 30.

According to the prior art, the air-oil mixture required for the seals of the pressurised enclosures 13 is directly injected in the accessory case 30 such that the degasser processes the combination of the air-oil mixture of the pressurised enclosures 13 and the oil mist 39 present in the accessory box, in particular formed by the oil 33 supplied by the nozzle 32 for lubricating the mechanical parts.

FIG. 2 is a very schematic view of the configuration of the deoiling system according to one embodiment of the invention. According to the invention, the air-oil mixture of the pressurised enclosures 13 of the turbine engine is no longer injected directly in the accessory case 30, but is guided directly towards the inlet 27 of the degasser by means of a duct 40 that connects the pressurised enclosures 13 to the inlet 27 of the degasser. This duct 40 thereby enables isolating the air-oil mixture coming from the pressurised enclosures 13 from the oil mist 39 present in the accessory case 30.

The arrangement of this duct 40 between the outlet of the pressurised enclosures 13 and the inlet of the degasser 27 therefore prevents the oil mist of the accessory case 30 from enriching the air-oil mixture of the pressurised enclosures 13 that is to be separated by the degasser 20.

The degasser 20 further comprises an outlet 28 for oil extracted from the mixture and an outlet 29 for deoiled air.

According to an embodiment of the invention, the oil outlet 28 is directly connected to the inside of the accessory case 30 so as to be able to lubricate the mechanical parts of the case.

According to another embodiment, which is not shown, the oil extracted from the mixture is injected in the oil tank 35.

This duct can, for example, pass through the accessory case 30 such that the degasser 20 remains housed in the accessory case.

According to another embodiment, which is not shown, the degasser is housed outside the accessory case and it is rotationally driven by means of a shaft that passes through the accessory case 30. The supply of the mixture can be achieved either by a duct such as that described in line with the embodiment of FIG. 2, or by direct diffusion of the mixture in the inlet of the degasser.

According to another version shown in FIG. 3, the supply of the air-oil mixture to the degasser 20 is achieved by way of the drive shaft 52 of the degasser. This drive shaft 52 is hollow such that one end 53 of the shaft can receive the mixture to be processed and the other end 54 of the drive shaft makes it possible for the evacuation of the deoiled air mixture. A partition 70 provided in the hollow shaft 52 further enables separating the inlet 53 from the outlet 54, thereby forcing the air mixture to pass into the enclosures 58a, 58b of the degasser. The circulation of the mixture coming from the turbine, i.e. from the shaft 10 to the inlet 53 of the degasser, is schematically shown by the arrows 59 in FIG. 3.

According to this embodiment, the degasser is furthermore rotationally driven by way of a pinion 60 mounted secured to the hollow shaft 52 and rotationally driven by the shaft 10.

In FIG. 3, it can also be observed that the degasser comprises two degassing enclosures arranged on the drive shaft thereof, an enclosure 58a intended to process the air-oil mixture coming from the seals and collected in an air inlet casing as described previously, and an enclosure 58b intended to process the oil mist present inside the accessory case. According to another version, the degasser can only comprise one degassing enclosure.

1. A system for deoiling an air-oil mixture for pressurizing pressurized enclosures of a turbine engine, said system comprising:
at least one centrifugal degasser comprising an enclosure for the separation of the mixture arranged around a drive shaft, an inlet of the mixture into said enclosure, and an air outlet for deoiled air and an oil outlet for oil extracted from said mixture,
at least one mechanical casing of the turbine engine comprising a plurality of mechanical parts, of which at least one is mechanically connected to said drive shaft of said degasser so as to drive degasser rotationally, said casing being configured to contain an oil mist for lubricating said mechanical parts,
wherein said deoiling system comprises the means to isolate said air-oil mixture with respect to the oil mist of said mechanical casing, such that said oil mist of said mechanical casing cannot enrich with oil said mixture to be separated by said degasser, and comprising a double degasser configured to be able to process, in a first enclosure, the air of the pressurized enclosures and, in a second enclosure, the air of the mechanical casing.

2. The system according to claim 1, wherein said isolation means of said mixture comprises a duct connecting directly said air outlet and said oil outlet of said pressurized enclosures to said inlet of said mixture in said enclosure of said degasser, such that said mixture of the pressurized enclosures directly supplies said degasser without interacting with said oil mist of the mechanical casing.

3. The system according to claim 2, wherein said degasser is housed in said mechanical casing said duct passes through said mechanical casing.

4. The system according to claim 3, wherein said drive shaft of said degasser is hollow and forms at least one portion of said duct connecting said pressurized enclosures of the turbine engine to the inlet.

5. The system according to claim 2, wherein said degasser is arranged between the mechanical casing and an air inlet casing of a compressor of the turbine engine.

6. The system according to claim 1 wherein said degasser is arranged outside said mechanical casing and said drive shaft of said degasser passes through said mechanical casing, said mechanical casing forming said isolation means of said mixture with respect to the oil mist of the mechanical casing.

7. The system according to claim 1, wherein the mechanical casing is one of a reduction gear casing or an accessory case of the turbine engine.

8. The system according to claim 1, wherein said oil outlet from said degasser opens into said casing.

9. The system according to claim 1, wherein said oil outlet from said degasser opens into an oil tank.

10. A turbine engine comprising a deoiling system according claim 1.
